(19) United States
(12) Patent Application Publication
(10) Pub. No.: US 2026/0174103 A1
(43) Pub. Date: Jun. 25, 2026

(54) TERNARY PROTEIN-BASED COMPOSITE SYSTEM AND PREPARATION METHOD THEREOF

(71) Applicant: Jilin Agricultural University, Changchun (CN)

(72) Inventors: Hao ZHANG, Changchun (CN); Tiantong LAN, Changchun (CN); Jingsheng LIU, Changchun (CN)

(21) Appl. No.: 19/306,264

(22) Filed: Aug. 21, 2025

(30) Foreign Application Priority Data
Dec. 20, 2024 (CN) 202411884503.X

(51) Int. Cl. A23J 3/16; A23L 29/10

(52) U.S. Cl. CPC A23J 3/16; A23L 29/10

(57) ABSTRACT

The present disclosure discloses a ternary protein-based composite system and the preparation method thereof, relating to the fields of functional foods and pharmaceuticals. Compared to a single soy protein isolate and the binary complexes thereof, the ternary composite systems SLE-7, SEL-7, SLE-9, SEL-9 exhibit significant changes in protein structure and stronger interactions. Studies shows that pH value and the addition sequence of raw materials significantly impact the particle size of the complexes and functional properties of the composite systems. At pH 7, SLE-7 shows the highest EAI and ESI among ternary complexes; at pH 9, SEL-9 shows the highest EAI and ESI among the ternary systems; SEL-9 possesses the smallest particle size and the most uniform system, with its composite emulsion demonstrating optimal emulsifying performance, making it suitable for application in functional foods and pharmaceuticals.

### CROSS-REFERENCE TO RELATED APPLICATIONS

This application claims priority to a Chinese Application No. 202411884503.X, filed on Dec. 20, 2024, titled “Ternary Protein-Based Composite System and Preparation Method Thereof”, the entire contents of which are hereby incorporated herein by reference in their entirety.

### TECHNICAL FIELD

The present disclosure relates to the field of functional foods and pharmaceuticals, and particularly relates to a ternary protein-based composite system and a preparation method thereof.

### BACKGROUND

Soy protein isolate (SPI, abbreviated as S in the present disclosure) plays an important role in the field of food processing due to its good functional properties such as emulsification, gelation, and foaming, scientific processing methods can more effectively enhance the application of SPI in the food industry, further broadening its application prospects. The main reason for selecting soy protein isolate in the present disclosure is its extremely high nutritional value, containing essential amino acids for the human body, it is one of the few plant proteins that can replace animal protein. Moreover, it has good water solubility, avoiding the issue of alcohol-soluble proteins being difficult to apply directly in foods.

Soy lecithin (abbreviated as L in the present disclosure) is an amphiphilic molecule composed of a hydrophobic tail (fatty acid chain) and a hydrophilic head (phosphatidyl substituent), it is an important natural emulsifier, widely used as a zwitterionic surfactant in food processing, it can alter the secondary structure of proteins through hydrophobic interactions, thereby improving the physicochemical and functional properties of proteins. Furthermore, it is rich in nutrients, can reduce serum cholesterol levels, treat diabetes, prevent and treat arteriosclerosis, etc., making it suitable for people with high blood pressure, high blood sugar, and high blood lipids. In the present disclosure, soy lecithin is selected as the lipid substance because it is derived from soybeans, aiming to further promote the whole-plant utilization of soybeans.

Epigallocatechin gallate (EGCG, abbreviated as E in the present disclosure) is a natural hydrophilic polyphenol with abundant phenolic hydroxyl groups, it is safe and non-toxic, has strong antioxidant activity, can extend the shelf life of food, improve food quality, maintain its original color and nutritional level for a long time, and also makes significant contributions to the prevention of cancer and cardiovascular diseases, it can also promote interactions with various substances, such as proteins. However, due to sensitivity to heat and ultraviolet light, EGCG is also prone to oxidation and degradation.

Currently, there is no research on a soy protein isolate-soy lecithin-EGCG ternary composite system.

### SUMMARY OF THE INVENTION

The objective of the present disclosure is to propose a ternary protein-based composite system and a preparation method thereof, by compounding soy protein isolate with soy lecithin and EGCG at different pH values and addition sequences, its physicochemical and functional properties are studied to further enhance the performance of the composite system, with the aim of further promoting the high-quality development of the protein-based food industry.

To achieve the above objective, the technical solution of the present disclosure is as follows:

In a first aspect, the present disclosure proposes a preparation method for a ternary protein-based composite system, by adjusting the pH value in a soy protein isolate solution and add soy lecithin and EGCG, a ternary protein-based composite system at pH 7-9 is obtained, wherein the mass ratio of soy protein isolate to soy lecithin is 10:1, and the mass ratio of soy protein isolate to EGCG is 20:1.

Preferably, in the aforementioned preparation method for the ternary protein-based composite system, in a soy protein isolate solution at pH 7, soy lecithin is first added to obtain a soy protein isolate-soy lecithin binary composite solution, then EGCG is added to obtain a soy protein isolate-soy lecithin-EGCG ternary composite solution.

Preferably, in the aforementioned preparation method for the ternary protein-based composite system, in a soy protein isolate solution at pH 9, EGCG is first added to obtain a soy protein isolate-EGCG binary composite solution, then soy lecithin is added to obtain a soy protein isolate-EGCG-soy lecithin ternary composite solution.

Preferably, the aforementioned preparation method for the ternary protein-based composite system comprises the following steps:
S1: weigh soy protein isolate powder, dissolve it in distilled water, adjust the pH to 7, magnetically stir overnight, add soy lecithin at a mass ratio of soy protein isolate to soy lecithin of 10:1, magnetically stir for 3 h, to obtain a soy protein isolate-soy lecithin binary composite solution at pH 7;
S2: On the basis of the obtained binary composite solution, add EGCG at a mass ratio of soy protein isolate to EGCG of 20:1, magnetically stir for 3 h, to obtain a soy protein isolate-soy lecithin-EGCG ternary composite solution at pH 7.

Preferably, the aforementioned preparation method for the ternary protein-based composite system comprises the following steps:
S1: weigh soy protein isolate powder, dissolve it in distilled water, adjust the pH to 7, magnetically stir overnight, add EGCG at a mass ratio of soy protein isolate to EGCG of 20:1, magnetically stir for 3 h, to obtain a soy protein isolate-EGCG binary composite solution at pH 7;
S2: On the basis of the obtained binary composite solution, add a lipid substance at a mass ratio of soy protein isolate to soy lecithin of 10:1, and magnetically stir for 3 h to obtain a soy protein isolate-EGCG-soy lecithin ternary composite solution at pH 7.

Preferably, the aforementioned preparation method for the ternary protein-based composite system comprises the following steps:
S1: weigh soy protein isolate powder, dissolve it in distilled water, adjust the pH to 9, magnetically stir overnight, add soy lecithin at a mass ratio of soy protein isolate to soy lecithin of 10:1, magnetically stir for 3 h, to obtain a soy protein isolate-soy lecithin binary composite solution at pH 9;
S2: On the basis of the obtained binary composite solution, add EGCG at a mass ratio of soy protein isolate to EGCG of 20:1, magnetically stir for 3 h, to obtain a soy protein isolate-soy lecithin-EGCG ternary composite solution at pH 9.

Preferably, the aforementioned preparation method for the ternary protein-based composite system comprises the following steps:
S1: weigh soy protein isolate powder and dissolve it in distilled water, adjust the pH to 9, magnetically stir overnight, add EGCG at a mass ratio of soy protein isolate to EGCG of 20:1, magnetically stir for 3 h, to obtain a soy protein isolate-EGCG binary composite solution at pH 9;
S2: On the basis of the obtained binary composite solution, add a lipid substance (soy lecithin) at a mass ratio of soy protein isolate to soy lecithin of 10:1, magnetically stir for 3 h, to obtain a soy protein isolate-EGCG-soy lecithin ternary composite solution at pH 9.

In a second aspect, the present disclosure provides a ternary protein-based composite system, prepared by any one of the aforementioned methods.

Compared with the prior art, the technical effects of the present disclosure are:

The ternary protein-based composite system proposed by the present disclosure, compared to a single soy protein isolate and its binary complexes, shows that the protein structures of the ternary composite systems SLE-7, SEL-7, SLE-9, and SEL-9 have undergone significant changes, and the ternary systems exhibit stronger interactions. Through further research, it was found that the pH and the addition sequence of the raw materials have a significant impact on the particle size of the complexes and the functional properties of the composite systems. At pH 7, SLE-7 in the ternary complex has the highest EAI and ESI; at pH 9, SEL-9 in the ternary system has the highest EAI and ESI; among them, SEL-9 has the smallest particle size and the most uniform system, and the SEL-9 composite emulsion exhibits the best emulsifying performance. The above research has identified several preferred ternary protein-based composite systems, wherein SEL-9 is the most preferred ternary protein-based composite system, ensuring its application in the fields of functional foods and pharmaceuticals.

### BRIEF DESCRIPTION OF THE DRAWINGS

FIG. 1 is a photograph of the ternary complexes provided by the embodiments of the present disclosure.

FIG. 2A is a fluorescence spectrum of the ternary complexes SEL-7, SLE-7, SE-7, SL-7 and S-7 provided by the embodiments of the present disclosure.

FIG. 2B is a fluorescence spectrum of the ternary complexes SEL-9, SLE-9, SE-9, SL-9 and S-9 provided by the embodiments of the present disclosure.

FIG. 3 is an ultraviolet spectrum of the ternary complexes provided by the embodiments of the present disclosure.

FIG. 4 is a Fourier transform infrared spectrum of the ternary complexes provided by the embodiments of the present disclosure.

FIG. 5 is a diagram of the absolute enthalpy values from differential scanning calorimetry (DSC) of the ternary complexes provided by the embodiments of the present disclosure.

FIG. 6A is a diagram of the particle size and PDI of the ternary complexes SEL-7, SLE-7, SE-7, SL-7 and S-7 provided by the embodiments of the present disclosure.

FIG. 6B is a diagram of the particle size and PDI of the ternary complexes SEL-9, SLE-9, SE-9, SL-9 and S-9 provided by the embodiments of the present disclosure.

FIG. 7 is a diagram of the zeta potential of the ternary complexes provided by the embodiments of the present disclosure.

FIG. 8A is a diagram of the emulsifying activity and emulsifying stability of the ternary complexes SEL-7, SLE-7, SE-7, SL-7 and S-7 provided by the embodiments of the present disclosure.

FIG. 8B is a diagram of the emulsifying activity and emulsifying stability of the ternary complexes SEL-9, SLE-9, SE-9, SL-9 and S-9 provided by the embodiments of the present disclosure.

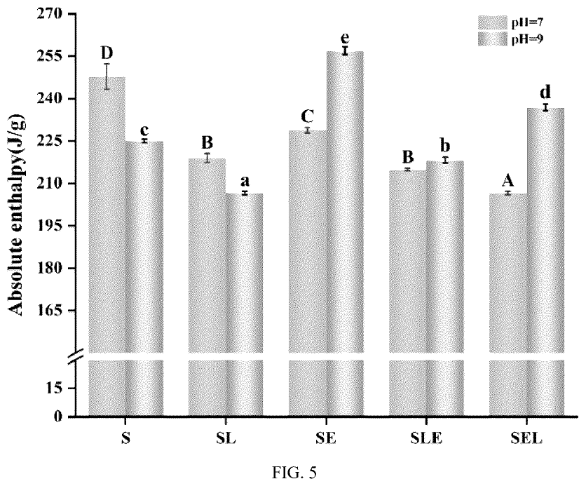

In FIGS. 5-8, data points marked with different letters indicate significant differences at the 0.05 level.

### DETAILED DESCRIPTION

To enable those skilled in the art to better understand the technical solutions of the present disclosure, the present disclosure will be further described in detail below in conjunction with embodiments and the accompanying drawings. Obviously, the described embodiments are only a part of the embodiments of the present disclosure, and not all of them. Based on the embodiments of the present disclosure, all other embodiments obtained by persons of ordinary skill in the art without making creative efforts shall fall within the protection scope of the present disclosure.

The experimental methods in the following embodiments are conventional methods unless otherwise specified.

The test materials used in the following embodiments are purchased from conventional biochemical reagent stores unless otherwise specified. Soy protein isolate was purchased from Shanghai Yuanye Bio-Technology Co., Ltd. Soy lecithin was purchased from Shanghai Macklin Biochemical Co., Ltd. EGCG was purchased from Xi'an Tongze Biotechnology Co., Ltd.

### 1. Preparation of Composite Systems

(1). Weigh soy protein isolate powder and dissolve it in distilled water, add soy lecithin at mass ratios of 30:1, 25:1, 20:1, 15:1, 10:1, and 5:1 to obtain soy protein isolate-soy lecithin binary systems. Preliminary experiments determined that a mass ratio of 10:1 was the optimal ratio, providing the best emulsifying performance and superior functional characteristics.

(2). Weigh soy protein isolate powder and dissolve it in distilled water, add EGCG at mass ratios of 50:1, 40:1, 30:1, 20:1, and 10:1 to obtain soy protein isolate-EGCG binary systems. Preliminary experiments determined that a mass ratio of 20:1 was the optimal ratio, providing the best thermal stability and the most uniform system.

(3). Weigh soy protein isolate powder and dissolve it in distilled water, adjust the pH to 5, 7, 9, and 11. Preliminary experiments showed that overly acidic or alkaline conditions affect the protein structure, modifying the protein, making it unsuitable for direct application in the food field. Therefore, pH=7 and pH=9 were selected for subsequent experiments.

(4). Weigh soy protein isolate powder and dissolve it in distilled water, adjust the pH to 7, magnetically stir overnight, denoted as S-7. Add soy lecithin at a mass ratio of 10:1, magnetically stir for 3 h, to obtain a soy protein isolate-soy lecithin binary composite solution at pH 7, denoted as SL-7.

To the SL-7 binary composite solution, add EGCG at a mass ratio of 20:1, magnetically stir for 3 h, to obtain a soy protein isolate-soy lecithin-EGCG ternary composite solution at pH 7, denoted as SLE-7.

(5). Weigh soy protein isolate powder and dissolve it in distilled water, adjust the pH to 7, magnetically stir overnight, denoted as S-7. Add EGCG at a mass ratio of 20:1, magnetically stir for 3 h, to obtain a soy protein isolate-EGCG binary composite solution at pH 7, denoted as SE-7.

To the SE-7 binary composite solution, add soy lecithin at a mass ratio of 10:1, magnetically stir for 3 h, to obtain a soy protein isolate-EGCG-soy lecithin ternary composite solution at pH 7, denoted as SEL-7.

(6). Weigh soy protein isolate powder and dissolve it in distilled water, adjust the pH to 9, magnetically stir overnight, denoted as S-9. Add soy lecithin at a mass ratio of 10:1, magnetically stir for 3 h, to obtain a soy protein isolate-soy lecithin binary composite solution at pH 9, denoted as SL-9.

To the SL-9 binary composite solution, add EGCG at a mass ratio of 20:1, magnetically stir for 3 h, to obtain a soy protein isolate-soy lecithin-EGCG ternary composite solution at pH 9, denoted as SLE-9.

(7). Weigh soy protein isolate powder and dissolve it in distilled water, adjust the pH to 9, magnetically stir overnight, denoted as S-9. Add EGCG at a mass ratio of 20:1, magnetically stir for 3 h, to obtain a soy protein isolate-EGCG binary composite solution at pH 9, denoted as SE-9.

To the SE-9 binary composite solution, add soy lecithin at a mass ratio of 10:1, magnetically stir for 3 h, to obtain a soy protein isolate-EGCG-soy lecithin ternary composite solution at pH 9, denoted as SEL-9.

### 2. Determination of Visual Sample Images

Pour the sample into a colorimetric tube, place the tube in a colorimetric rack with a black velvet background, and take clear horizontal pictures.

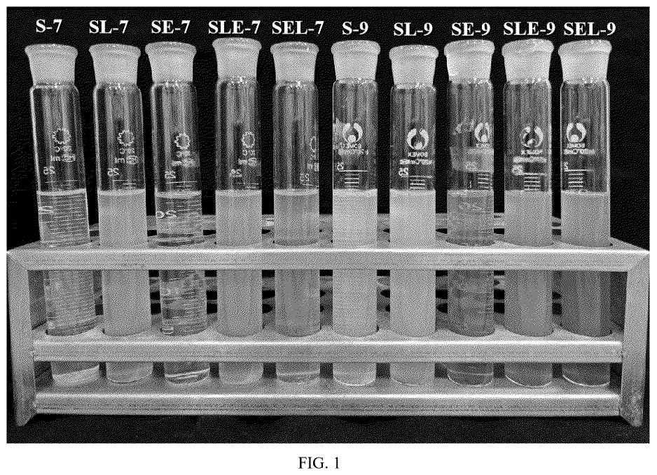

As shown in FIG. 1, the color and transparency of solutions prepared under different pH conditions and different addition sequences show very obvious differences. Wherein samples at pH 9 exhibit darker colors compared to their corresponding samples at pH 7. This is because the solubility of the protein further increases under alkaline conditions, and the protein structure unfolds further, enabling it to bind more soy lecithin and EGCG.

### 3. Determination of Fluorescence Spectra

Dilute the concentration of each sample solution to 0.5 mg/mL using deionized water, pipette the samples into a 96-well plate, measure using a fluorescence spectrometer with the excitation wavelength set to 280 nm and the emission spectrum scanned from 320-400 nm. The obtained fluorescence data were analyzed using Origin software.

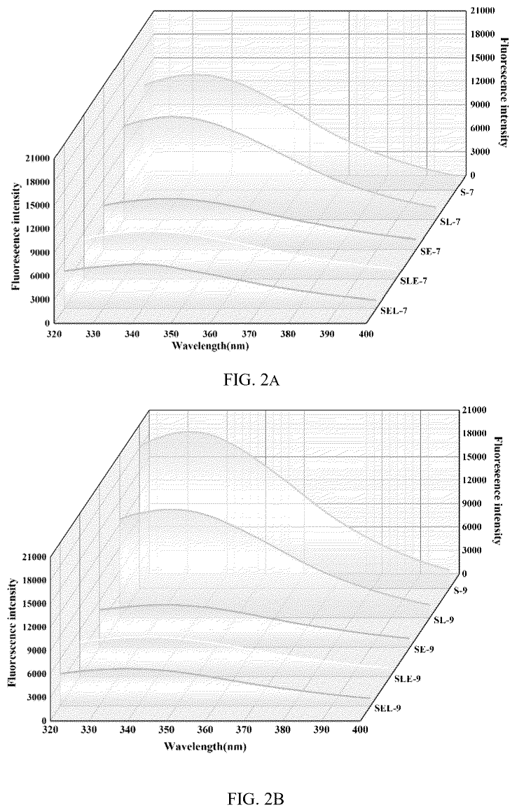

As shown in FIG. 2, the fluorescence intensity of all complexes decreased compared to the protein alone, accompanied by a certain degree of red shift. This is because the binding of soy lecithin and EGCG to the protein causes a fluorescence quenching effect, and their interactions induce a high degree of unfolding of the protein's microscopic structure, exposing amino acid residues to a more polar environment. Furthermore, under both pH conditions, the ternary complexes where EGCG was added first exhibited lower fluorescence intensity, this may be because EGCG itself has fluorescence quenching properties; add EGCG first can quench more of the protein's intrinsic fluorescence. Whereas soy lecithin binding to the protein first may form a protective layer on the protein surface, hindering the interaction between EGCG and the protein. At pH 9, the fluorescence intensity of pure SPI was significantly higher than at pH 7. This is because under alkaline conditions, the protein structure is more extended, exposing more tryptophan residues, and internal hydrophobic groups are further exposed on the molecular surface, leading to increased fluorescence intensity.

### 4. Determination of Ultraviolet Spectra

Dilute each sample to 0.5 mg/mL using deionized water, measure using an ultraviolet-visible (UV-Vis) spectrophotometer, use a 1 cm quartz cuvette, scan the absorbance of the sample within the wavelength range of 220-320 nm, use deionized water as the blank solution, set the slit width to 2 nm, resolution to 0.2 nm, and scanning speed was set to medium. The obtained spectral data were analyzed using Origin software.

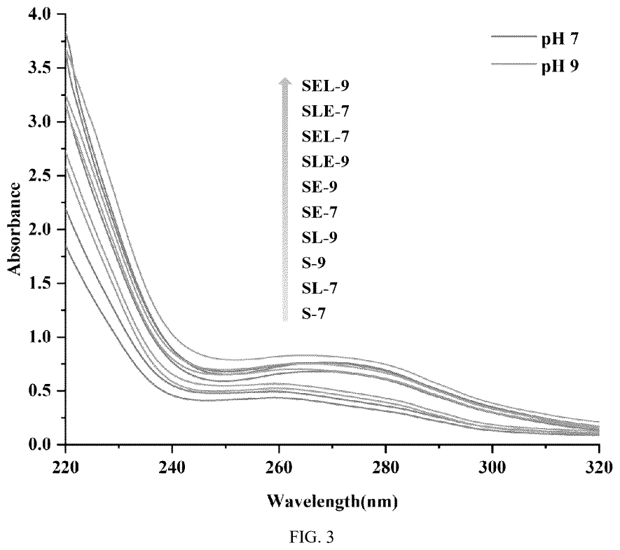

As shown in FIG. 3, under both pH conditions, the addition of soy lecithin and EGCG caused an increase in peak intensity accompanied by a red shift phenomenon. Among the binary complexes, SE showed higher intensity than SL. This is because the complex structure of EGCG, with multiple aromatic rings or hydroxyl functional groups, can induce structural changes through various types of interactions with the protein, while the lipid structure is relatively simpler, typically interacting more with the hydrophobic regions of the protein. In the ternary systems, the peak intensity of SEL-9 was much higher than SLE-9. This may be because covalent binding between the polyphenol and the protein can alter the protein structure to a greater extent, promoting the interaction between soy lecithin and the protein, which is consistent with the results obtained from fluorescence spectroscopy.

### 5. Determination of Fourier Transform Infrared Spectra

Mix the freeze-dried powdered samples with spectroscopic grade potassium bromide at a mass ratio of 1:100, grind the mixture thoroughly and press into pellets. Measure all samples using an Fourier Transform Infrared spectrometer at 25° C. over the wavenumber range of 400-4000 cm⁻¹, perform 64 scans per sample with a resolution of 4 cm⁻¹. Use a pure KBr pellet as the blank reference. The obtained infrared spectra were analyzed using Origin software.

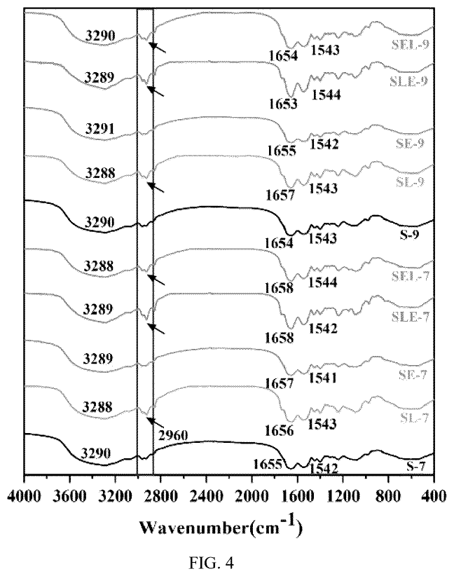

As shown in FIG. 4, S-7 showed a broad characteristic peak in the Amide A band at 3286 cm⁻¹. Compared to this, all complexes exhibited slight red or blue shifts. This is attributed to the stretching vibrations of intermolecular O—H and N—H, indicating hydrogen bonding interactions occurred between the complex components. The peaks near 1654 cm⁻¹ (Amide I) and 1542 cm⁻¹ in the complexes also showed slight red shifts. These shifts are attributed to C—N and C═O stretching vibrations, and N—H bending vibrations combined with C—N and C—C stretching vibrations, suggesting the formation of electrostatic interactions within the complexes. At pH 7, soy lecithin and EGCG primarily bind to the protein through non-covalent interactions like hydrogen bonding and hydrophobic forces. At pH 9, the intensity change of the characteristic peak at 3290 cm⁻¹ for SE-9 and SEL-9 covalent complexes compared to S-9 was reduced. This may be because under alkaline conditions, hydroxyl groups of EGCG are oxidized to quinones, reducing hydroxyl content and weakening hydrogen bond formation. The change in peak intensity for SE-9 in the Amide I and Amide II bands might be due to covalent binding of EGCG with SPI participating in C—N and N—H vibrations.

### 6. Determination of Thermal Stability

Weigh 4-5 mg of freeze-dried powdered sample into an aluminum crucible. Use an empty crucible as the reference. Place both the sample crucible and the reference crucible inside the instrument. After measurement is complete, remove them. Set the starting temperature to 20° C. and heat to an end temperature of 200° C. at a rate of 10° C./min. Set the nitrogen gas flow rate to 50 mL/min. After testing, analyze the thermal characteristics of the samples using the analysis software compatible with the instrument.

As shown in FIG. 5, at pH 7, with the addition of soy lecithin and EGCG, the absolute enthalpy value of the complexes showed a decreasing trend, indicating that less energy is required to disrupt the system. At pH 9, after adding EGCG (SE-9 compared to S-9, SLE-9 compared to SL-9), the absolute enthalpy values significantly increased. This is because the quinones generated from EGCG under alkaline conditions undergo nucleophilic reactions with sulfhydryl or amino groups in SPI, forming more structurally ordered complexes through covalent interactions via C—S or C—N bonds, thereby endowing them with higher thermal stability.

### 7. Determination of Particle Size and Polydispersity Index (PDI)

Dilute the sample solution to 1 mg/mL using ultrapure water. Measure the particle size and polydispersity index (PDI) of the samples using a nanoparticle size and zeta potential analyzer via dynamic light scattering (DLS).

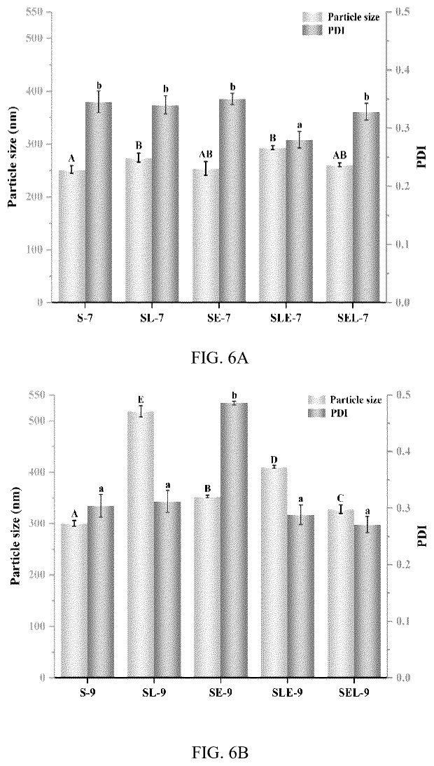

As shown in FIG. 6, under both pH conditions, the particle size of all complexes increased. The particle sizes of SLE-7 and SLE-9 were larger than those of SEL-7 and SEL-9, respectively. This is because when SPI contacts EGCG first, it reduces the binding between the protein and soy lecithin, and soy lecithin itself has a larger molecular structure. At pH 7, the particle sizes of the ternary systems showed an increasing trend. In contrast, at pH 9, the particle sizes of the ternary complexes significantly decreased. Furthermore, it is noteworthy that the overall particle sizes at pH 9 were larger than those at pH 7, particularly SL-9 (518.23±10.90 nm) was significantly larger than SL-7 (273.90±8.65 nm). From the PDI values, it can be seen that after adding the third component, the PDI values decreased, with SEL-9 reaching the lowest value of 0.27±0.01.

### 8. Determination of Zeta Potential

Dilute the sample solution to 1 mg/mL using ultrapure water. Measure the zeta potential of the samples using a nanoparticle size and zeta potential analyzer via dynamic light scattering (DLS).

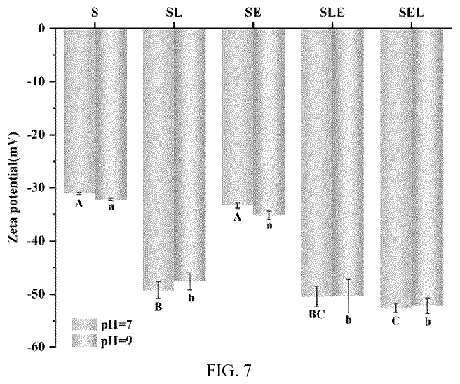

As shown in FIG. 7, all samples showed negative values. This is because soy protein isolate itself carries a large amount of negative charge under both pH conditions, and both soy lecithin and EGCG can also contribute negative charge to the complex. Therefore, binding with the protein increases the negative charge on the protein particle surface, leading to an increase in the absolute value of the potential. Moreover, the absolute zeta potential values of SE-9, SLE-9, and SEL-9 were higher than those of SE-7, SLE-7, and SEL-7, respectively. This is attributed to EGCG generating quinone compounds under alkaline environments, and quinones carry negative charge in covalent complexes.

### 9. Determination of Emulsifying Activity Index and Emulsifying Stability Index

Take the prepared emulsion and dilute it 100-fold with SDS (0.1%). Measure its absorbance at 500 nm at 0 min and 10 min. Emulsifying activity index (EAI) is represented by the absorbance at 0 min. Emulsifying stability index (ESI) is calculated as follows. Where A₀ and A₁₀ are the absorbances at 0 min and 10 min after emulsion standing, and T₀ and T₁₀ are 0 min and 10 min, respectively.

$$ESI ( min ) = \frac{{A}_{0}}{{A}_{0} - {A}_{10}} \times {T}_{10} - {T}_{0}$$

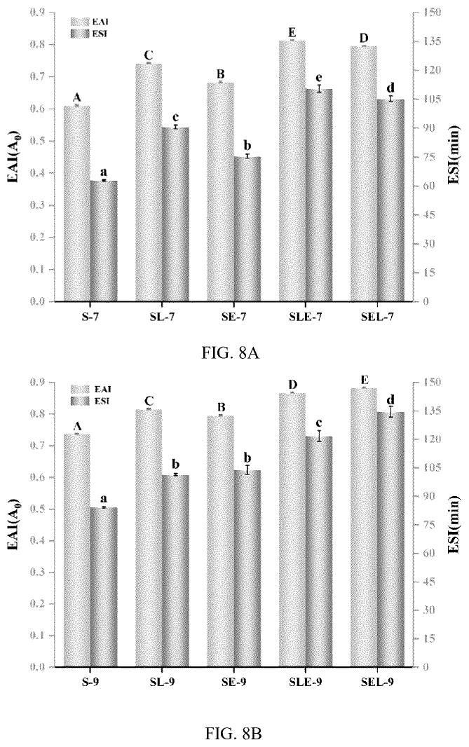

As shown in FIG. 8, at pH 7, among the binary complexes, SL-7 had the highest EAI and ESI. Among the ternary complexes, SLE-7 had the highest EAI and ESI. This is because soy lecithin is an excellent emulsifier; it can reduce the interfacial tension between components in the system and form a relatively strong film at the droplet surface or an electrical double layer to prevent droplet aggregation. When it binds to the protein first in the system, a more stable protective layer can form at the emulsion interface during emulsification, preventing oil droplet aggregation and coalescence, and maintaining emulsion uniformity. Although the interaction between EGCG and the protein can enhance protein flexibility and promote the exposure of buried hydrophobic amino acids and active sites on the protein surface, improving protein adsorption efficiency at the oil-water interface, its capability is relatively weaker compared to a dedicated emulsifier. At pH 9, among the binary systems, SL-9 had the highest EAI, while SE-9 had the highest ESI. Among the ternary systems, SEL-9 had the highest EAI and ESI. This may be because EGCG covalently interacting with SPI first improves the balance between the hydrophilicity and hydrophobicity of the protein.

Based on the above experimental results, we draw the following conclusions:

(1) From the color of visual samples, it can be concluded that more protein dissolves under alkaline conditions and binds more soy lecithin and EGCG.

(2) Fluorescence and UV spectroscopy tests indicate that interactions occurred between soy lecithin, EGCG, and the protein, altering the microenvironment of the protein's amino acid residues.

(3) FTIR spectral results show that the binding in non-covalent complexes is mainly driven by hydrogen bonding and hydrophobic interactions.

(4) DSC measurements indicate that the structure of the complexes is more ordered, requiring more energy to disrupt them.

(5) Particle size, PDI, and zeta potential measurements revealed that adding EGCG first reduces binding between the protein and soy lecithin, thereby decreasing particle size. Covalent binding occurring under alkaline conditions increases the particle size of the complexes. Among them, SEL-7 has the smallest particle size, and SEL-9 has the most uniform system.

(6) Emulsion activity and stability tests showed that adding soy lecithin and EGCG significantly improves emulsion performance.

The above description of certain exemplary embodiments of the present disclosure is by way of illustration only. Undoubtedly, for those of ordinary skill in the art, the described embodiments can be modified in various different ways without departing from the spirit and scope of the present disclosure. Therefore, the above drawings and description are illustrative in nature and should not be construed as limiting the scope of the claims of the present disclosure.

What is claimed is:

1. A method for preparing a ternary protein-based composite system, characterized in that, in a soy protein isolate solution at pH 9, EGCG is first added to obtain a soy protein isolate-EGCG binary composite solution, and soy lecithin is then added to obtain a soy protein isolate-EGCG-soy lecithin ternary composite solution, wherein the mass ratio of soy protein isolate to EGCG is 20:1 and the mass ratio of soy protein isolate to soy lecithin is 10:1.

2. The method for preparing a ternary protein-based composite system according to claim 1, characterized in that it comprises the following steps:
S1. weigh soy protein isolate powder, dissolve it in distilled water, adjust the pH to 9, magnetically stir overnight, add EGCG at a mass ratio of soy protein isolate to EGCG of 20:1, and magnetically stir for 3 h to obtain a soy protein isolate-EGCG binary composite solution at pH 9;
S2. on the basis of the obtained binary composite solution, add a lipid substance at a mass ratio of soy protein isolate to soy lecithin of 10:1, and magnetically stir for 3 h to obtain a soy protein isolate-EGCG-soy lecithin ternary composite solution at pH 9.

3. A ternary protein-based composite system, characterized in that the ternary protein-based composite system is prepared by the method according to claim 1.
